(19) United States
(12) Patent Application Publication
(10) Pub. No.: US 2026/0321515 A1
(43) Pub. Date: Oct. 15, 2026

(54) ELECTRONIC DEVICE

(71) Applicant: TDK Corporation, Tokyo (JP)

(72) Inventors: Akira SATO, Tokyo (JP); Kazuya MUTO, Tokyo (JP)

(73) Assignee: TDK Corporation, Tokyo (JP)

(21) Appl. No.: 19/576,005

(22) Filed: Mar. 24, 2026

(30) Foreign Application Priority Data
Apr. 15, 2025 (JP) 2025-066904

(51) Int. Cl. H01G 4/33; H01G 4/005; H01G 4/10; H01G 4/228

(52) U.S. Cl. CPC H01G 4/33; H01G 4/005; H01G 4/10; H01G 4/228

(57) ABSTRACT

An electronic device, including: a dielectric element body, a multilayer electrode connected to a surface of the dielectric element body, and a lead part connected to a surface of the multilayer electrode; wherein the multilayer electrode includes an innermost electrode layer contacting the dielectric element body and an outermost electrode layer contacting the lead part; and the innermost electrode layer includes a Ti membrane mainly including Ti, and the outermost electrode layer includes a metal membrane.

### TECHNICAL FIELD

The present disclosure relates to an electronic device.

### BACKGROUND

Patent document 1 discloses a radial lead electronic device. The radial lead electronic device disclosed in Patent document 1 has a specific structure which enables to achieve an excellent vibration resistance and also enables stable placement of the electronic device.

### PRIOR ART DOCUMENT

### Patent Document

[Patent Document 1] JP Patent Application Laid Open No. 2011-96899

### SUMMARY

An electronic device, according to the present disclosure includes: a dielectric element body, a multilayer electrode connected to a surface of the dielectric element body, and a lead part connected to a surface of the multilayer electrode; wherein the multilayer electrode comprises an innermost electrode layer contacting the dielectric element body and an outermost electrode layer contacting the lead part; and the innermost electrode layer includes a Ti membrane mainly including Ti, and the outermost electrode layer includes a metal membrane.

### BRIEF DESCRIPTION OF DRAWINGS

FIG. 1 is a schematic figure of a capacitor.

FIG. 2 is a schematic cross-section of a dielectric element body and a multilayer electrode.

### DETAILED DESCRIPTION

The object of exemplary embodiments of the present disclosure is to provide an electronic device which hardly causes an electrostrictive breakdown during a Ring Wave test.

The electronic device according to the present disclosure may include an outermost electrode layer including a Cu membrane which mainly includes Cu.

The electronic device according to present disclosure may include an innermost electrode layer having a thickness of 50 nm or thicker.

The thickness of the innermost electrode layer may be 150 nm or thinner.

The electronic device according to the present disclosure may include a dielectric element body in which a perovskite oxide is included as a main component.

The electronic device according to present disclosure, wherein the perovskite oxide may include one or more elements selected from the group consisting of Ba and Ca as an A-site element, and one or more elements selected from the group consisting of Ti and Zr as a B-site element.

The electronic device according to the present disclosure, wherein a content ratio of Zr to a total amount of Ti and Zr included as the B-site element in the perovskite oxide may be between greater than 0 and 0.20 or less in terms of number of atoms.

The electronic device according to the present disclosure, wherein the dielectric element body includes MnO as a subcomponent.

A thickness of the outermost electrode layer may be 50 nm or thicker and 150 nm or thinner.

The electronic device according to the present disclosure, wherein the multilayer electrode may include at least one middle electrode layer between the innermost electrode layer and the outermost electrode layer.

The electronic device according to the present disclosure, wherein the at least one middle electrode layer may include an outside-middle electrode layer contacting the outermost electrode layer, and the outside-electrode layer may include a Ni membrane mainly including Ni.

A thickness of the outside-middle electrode layer may be between 50 nm or thicker and 150 nm or thinner.

The electronic device according to the present disclosure may include an inside-middle electrode layer between the innermost electrode layer and the outside-electrode layer, and the inside-middle electrode layer may include a Cu membrane mainly including Cu.

A thickness of the inside-middle electrode layer may be between 130 nm or thicker and 390 nm or thinner.

The electronic device according to the present disclosure, wherein a thickness t1 of the innermost electrode layer and a thickness t2 of the inside-middle electrode layer may satisfy a relation of t2/t1 of 1.6 or greater.

The multilayer electrode of the electronic device according to the present disclosure may include a spattered membrane.

Below describes the embodiments of the present disclosure by referring to the figures. The embodiments of the present disclosure described below are examples for explaining the present disclosure, and each configuration element according to the embodiments, such as numerical values, shapes, materials, and manufacturing steps may be changed or modified as long as such change/modification does not cause technical challenges. Also, the shapes, etc., shown in the figures of the present disclosure may not necessarily precisely match the actual shapes and sizes. This is because, in the figures, the shapes and the sizes may be modified for explanation.

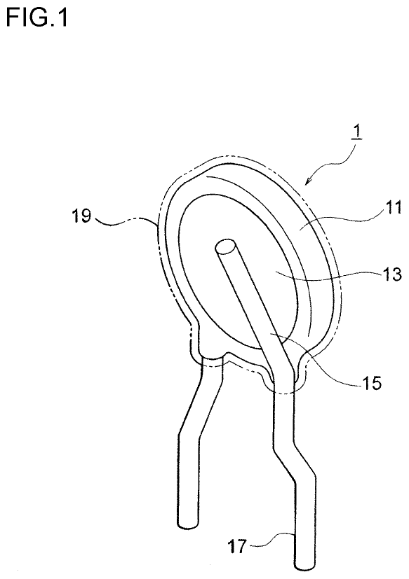

FIG. 1 is a schematic figure of a capacitor 1 which is one type of the electronic devices according to the present disclosure. The capacitor 1 is a disc capacitor. A disc capacitor is mainly for a medium/high voltage use.

The capacitor 1 includes a dielectric element body 11, a multilayer electrode 13 formed on both main surfaces of the dielectric element body 11, a lead part 17 electrically connected to the multilayer electrode 13 via a solder 15, and an exterior part 19 covering configuration components of the capacitor 1. Note that, in FIG. 1, part of the exterior part 19 is not shown in order to show the internal structure of the capacitor 1.

A composition of the dielectric element body 11 is not particularly limited. The dielectric element body 11 may include a perovskite oxide as a main component. A content ratio of the perovskite oxide in the dielectric element body 11 is not particularly limited. In the case of including the perovskite oxide as the main component, a resistance to reduction tends to increase relatively easily. By using the multilayer electrode 13 in which an innermost electrode layer 13a is a Ti membrane, an electrostriction tends to increase easily, however, a breakdown voltage of a Ring Wave test tends to easily improve.

The perovskite oxide is an oxide which is represented by a composition formula of ABO₃. However, a ratio of A-site element, B-site element, and O of the perovskite compound may not necessarily match a stoichiometric amount. That is, the ratio of A-site element, B-site element, and O of the perovskite oxide may not be 1:1:3. The ratio of the A-site element, B-site element, and O of the perovskite oxide may be shifted form the stoichiometric amount within a range which does not compromise the object of the present disclosure.

The perovskite oxide may include one or more elements selected from the group consisting of Ba and Ca as the A-site element, and one or more elements selected from the group consisting of Ti and Zr as the B-site element. The perovskite oxide including one or more elements selected from the group consisting of Ba and Ca as the A-site element, and one or more elements selected from the group consisting of Ti and Zr as the B-site element may be referred to as “BCTZ”.

In the perovskite oxide, a content ratio of Ba to a total amount of Ba and Ca included as the A-site element may be between 0.7 or greater and 1.0 or less in terms of the number of atoms.

In the perovskite oxide, a content ratio of Zr to a total amount of Ti and Zr included as the B-site element may be between greater than 0 and 0.20 or less in terms of the number of atoms. The content ratio of Zr to a total amount of Ti and Zr may be between 0.01 or greater and 0.20 or less, or 0.08 or greater and 0.11 or less. When the content ratio of Zr is within the above-mentioned range, the resistance to reduction of the dielectric element body 11 tends to further improve. Also, the breakdown voltage of a Ring Wave test, which is described later, tends to further improve. Further, an E-characteristic tends to be ensured.

The dielectric element body 11 may include MnO as the subcomponent. By including MnO as the subcomponent in the dielectric element body 11, the resistance to reduction of the dielectric element body 11 tends to be ensured easier. A content ratio of MnO in the dielectric element body 11 is not particularly limited. For example, when a content of the perovskite oxide as the main component is 100 parts by weight, the content ratio of MnO may be between 0.01 parts by weight or more and 0.08 parts by weight or less, or between 0.02 parts by weight or more and 0.04 parts by weight or less. Also, when the content ratio of MnO is too small or too large, the breakdown voltage of a Ring Wave test, which is described later, tends to decrease.

The dielectric element body 11 may include a component other than the perovskite oxide and MnO. Within the range which does not compromise the object of the present disclosure, rare earth elements, V, Al, Ni, etc., may be included. A content ratio of the component other than the perovskite oxide and MnO is not particularly limited.

A total thickness of the multilayer electrode 13 is not particularly limited. The total thickness may be between 60 nm or thicker and 1300 nm or thinner.

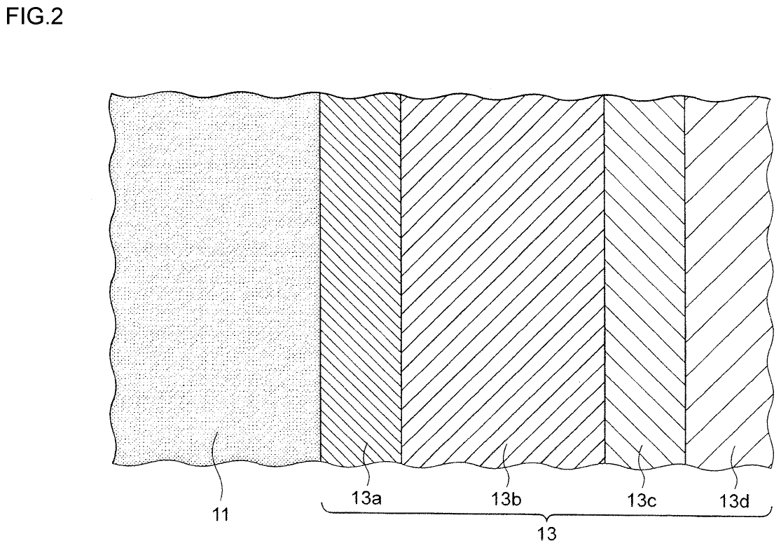

FIG. 2 is a schematic cross-section obtained by cutting the dielectric element body 11 and the multilayer electrode 13 along the thickness direction of the multilayer electrode 13. As shown in FIG. 2, the multilayer electrode 13 at least includes the innermost electrode layer 13a contacting the dielectric element body 11 and the outermost electrode layer 13d which is at the outermost side.

Further, the multilayer electrode 13 may include at least one middle electrode layer between the innermost electrode layer 13a and the outermost electrode layer 13d. For example, as shown in FIG. 2, an outside-middle electrode layer 13c, which contacts the outermost electrode layer 13d, may be included. Further, an inside-middle electrode layer 13b which is provided between the innermost electrode layer 13a and the outside-middle electrode layer 13c may be included.

The innermost electrode layer 13a is a Ti membrane mainly including Ti. That is, a content ratio of Ti in the innermost electrode layer 13a is 60% or greater in terms of the number of atoms.

In the capacitor according to the present disclosure, the innermost electrode layer 13a is a Ti membrane; thereby it is possible to improve the breakdown voltage of a Ring Wave test which is described later. Also, the adhesiveness with the dielectric element body 11 can be improved. Note that, in the case of using a single layer membrane made of Ti instead of using the multilayer electrode 13, because Ti is easily oxidized, an environmental resistance significantly declines and a dielectric loss tan δ tends to increase overtime. At the same time, the dielectric element body 11 tends to be easily reduced, thus, the characteristics of the capacitor 1 tends to decline.

A thickness of the innermost electrode layer 13a is not particularly limited. The thickness of the innermost electrode layer 13a may be 30 nm or thicker, or 50 nm or thicker. It may be 200 nm or thinner, or 150 nm or thinner. It may be between 30 nm or thicker and 200 nm or thinner, or between 50 nm or thicker and 150 nm or thinner. Also, in the case that the innermost electrode layer 13a is too thin, the breakdown voltage of a Ring Wave test tends to decrease. Also, the thinner the innermost electrode layer 13a, the lower the resistance against a thermal shock. Further, the breakdown at relatively low AC voltage tends to easily occur, and an AC breakdown electric field intensity VB tends to widely vary. The thicker the innermost electrode layer 13a, the larger the tan δ of the capacitor 1 tends to be. Further, the breakdown at relatively low AC voltage tends to easily occur, and an VB tends to become wider.

A composition of the outermost electrode layer 13d is not particularly limited, and the outermost electrode layer 13d may be a Cu membrane which mainly includes Cu. That is, a content ratio of Cu in the outermost electrode layer 13d may be 80% or greater in terms of the number of atoms.

A thickness of the outermost electrode layer 13d is not particularly limited. It may be between 30 nm or thicker and 300 nm or thinner, or between 50 nm or thicker and 150 nm or thinner. In the case that the outermost electrode layer 13d is too thin, the surface of the multilayer electrode 13 is easily oxidized and discoloration tends to occur. Further, a solder property of the multilayer electrode 13 tends to decline. In the case that the outermost electrode layer 13d is too thick, when compared to the case having an appropriate thickness of the outermost electrode layer 13d, improvements of various properties may not be significant yet the material cost may only increase.

A composition of the outside-middle electrode layer 13c is not particularly limited, and the outside-middle electrode layer 13c may be a Ni membrane which mainly includes Ni. That is, a content ratio of Ni in the outside-middle electrode layer 13c may be 80% or greater in terms of the number of atoms. In such case, the outside-middle electrode layer 13c functions as a barrier membrane to prevent solder erosion.

A thickness of the outside-middle electrode layer 13c is not particularly limited. It may be between 30 nm or thicker and 300 nm or thinner, or between 50 nm or thicker and 150 nm or thinner. Also, in the case that the outside-middle electrode layer 13c is too thin, a high temperature resistance tends to decrease. This is because a solder erosion is thought to easily occur. Also, in the case that the outside-middle electrode layer 13c is too thick, a thermal shock resistance tends to decrease. This is because it is thought that an increase in stress tends to easily cause a membrane release.

A composition of the inside-middle electrode layer 13b is not particularly limited, and the inside-middle electrode layer 13b may be a Cu membrane which mainly includes Cu. That is, a content ratio of Cu in the inside-middle electrode layer 13b may be 80% or greater in terms of the number of atoms.

A thickness of the inside-middle electrode layer 13b is not particularly limited. It may be between 100 nm or thicker and 500 nm or thinner, or between 130 nm or thicker and 390 nm or thinner. In the case that the inside-middle electrode layer 13b is too thin, t2/t1 which is described later tends to decrease unless the innermost electrode layer 13a is thinned down. If the innermost electrode layer 13a is thinned down, the breakdown voltage of a Ring Wave test as mentioned in above tends to decrease, the thermal shock resistance tends to decrease, and variation of VB tends to become wider. In the case that the inside-middle electrode layer 13b is too thick, compared to the case having an appropriate thickness of the inside-middle electrode layer 13b, improvements of various properties may not be significant yet the material cost may only increase. Also, the thermal shock resistance tends to decrease.

A thickness t1 of the innermost electrode layer 13a and a thickness t2 of the inside-middle electrode layer 13b may satisfy a relation t2/t1 of 1.6 or greater. By satisfying such relation, a conductivity of the multilayer electrode 13 becomes difficult to decrease particularly under high temperature environment. Further, it becomes difficult to reduce the dielectric element body 11 under high temperature environment. When t2/t1 decreases, the high temperature resistance tends to decline. This is because when t2/t1 decreases, the conductivity of the multilayer electrode 13 tends to decrease, and the dielectric element body 11 tends to be reduced easily.

Below describes a Ring Wave test.

A Ring Wave is one type of lightning surge. When using an electronic device including the capacitor 1, lightening may strike. An electric potential of a ground changes due to the lightning strike. Due to the change in the electric potential of the ground, a high energy noise may be induced to power lines, communication lines, etc. Thereby, the capacitor 1 may undergo electrostrictive breakdown due to such noise.

A Ring Wave test simulates the above-mentioned high energy noise existing in natural environment. That is, a high energy voltage is instantaneously applied to the capacitor 1. The maximum value of the voltage at this moment is deemed an open circuit voltage. Voltages are applied for several times by increasing the open circuit voltage, and an open circuit voltage at the moment when electrostrictive breakdown occurs to the dielectric element body 11 is deemed a breakdown voltage of a Ring Wave test.

When electrostrictive breakdown occurs to the dielectric element body, raptured surfaces, vertical cracks, breakdown scars, concentric cracks, etc., may be observed on the dielectric element body. That is, the electrostrictive breakdown can be visibly confirmed on the appearance of the dielectric element body 11 after the voltage is applied. Also, it is possible to confirm the electrostrictive breakdown from the sound generated when the voltage is applied.

The larger the permittivity of the dielectric element body 11, the larger the capacitance of the capacitor 1. However, the larger the permittivity of the dielectric element body 11, the easier it is for electrostriction to increase. Hence, the breakdown voltage tends to decrease during a Ring Wave test. In the capacitor 1 according to the present disclosure, particularly the innermost electrode layer 13a of the multilayer electrode 13 is a Ti membrane mainly including Ti. Thus, it is possible to increase the breakdown voltage of a Ring Wave test compared to the case using a conventional fired electrode.

Below describes a manufacturing method of the capacitor 1; however, the manufacturing method of the capacitor 1 is not particularly limited.

First, the dielectric element body 11 is prepared. A method for preparing the dielectric element body 11 is not particularly limited. For example, as a raw material powder of the main component of the dielectric element body 11, a powder of oxide and/or a compound which forms, after the heat treatment, oxide of each element such as Ba, Ca, Ti, and Zr is prepared. Further, as a raw material powder of the subcomponent of the dielectric element body 11, a powder of oxides and/or a compound which form, after the heat treatment, oxide of each element such as Mn is prepared.

Each powder prepared to obtain the main component having a target composition is weighed. Next, the raw material powders of the main component are mixed, and calcined to give a calcined powder. Then, the calcined powder and the raw material powder of the subcomponent are mixed to give a mixed powder. Pressure is applied to the mixed powder to give a molded body. The molded body is sintered to give a sintered body. A shape of the sintered body may be processed appropriately. As such, the dielectric element body 11 having the predetermined composition and shape is obtained.

A mixing method of each powder is not particularly limited. For example, the raw material powders may be mixed all at once. In such case, calcination may be skipped. Also, some of the raw material powder of the main component may not be calcined, and may be added to the calcined powder together with the raw material powder of the subcomponents.

Next, the multilayer electrode 13 is formed on both main surfaces of the dielectric element body 11. A method for forming the multilayer electrode 13 is not particularly limited. For example, the multilayer electrode 13 can be formed by spattering while appropriately changing the spattering target. That is, the multilayer electrode 13 may be a spattered membrane. Alternatively, instead of spattering, the multilayer electrode 13 may be formed using a thin membrane forming method such as ion plating or so.

Next, the multilayer electrode 13 and the lead part 17 are connected via the solder 15. Then, an exterior part 19 is formed. A method for forming the exterior part 19 is not particularly limited. Examples of a method for forming include a resin mold method.

The electronic device according to the present disclosure may be used for any purpose. Particularly, the electronic device according to the present disclosure is suitable for the use which requires a high breakdown voltage of a Ring Wave test while achieving high capacitance; that is, which requires a strong resistance against lightning surge.

### EXAMPLES

Hereinafter, the present disclosure is explained based on more detailed examples, but the present disclosure is not limited to the examples.

### Experiment Example 1

### (Dielectric Element Body)

As raw material powders of a main component, BaCO₃ powder, CaCO₃ powder, TiO₂ powder, and ZrO₂ powder were prepared. Further, as a raw material powder of a subcomponent, MnCO₃ powder was prepared. Then, each powder was weighed so that a content ratio of Ca with respect to a total amount of Ba and Ca which were included as A-site elements of the main component included in the dielectric element body obtained at the end was (Ca/(Ba+Ca)) of 0.11 in terms of number of atoms. Also, each powder was weighed so that a content ratio of Zr with respect to a total amount of Ti and Zr included as B-site elements of the main component included in the dielectric element body obtained at the end satisfied values of (Zr/(Ti+Zr)) in terms of the number of atoms as shown in Table 1. Also, a total content of A-site elements with respect to a total content of B-site elements was adjusted to satisfy A/B of 1.00 In terms of the number of atoms.

A content ratio of Mn with respect to 100 parts by weight of the main component included in the dielectric element body obtained at the end was adjusted to satisfy the values shown in Table 1 which were in terms of MnO.

The BaCO₃ powder, the CaCO₃ powder, the TiO₂ powder, and the ZrO₂ powder, which were weighed, were wet-mixed for 20 hours in a ball mill using water as a solvent. The obtained mixed powder was calcined for 2 hours at a holding temperature between 110° and 1220° C. to give a calcined material including the main component. Next, the obtained calcined material was wet-pulverized using a ball mill while adding the MnCO₃ powder to give a mixed powder. An organic binder (polyvinyl alcohol) was added to 100 parts by weight of the obtained mixed powder for granulation to give a granulated powder.

Pressure of 100 Mpa was applied on the granulated powder to give a molded body. The molded body was shaped to have a circular disc shape of a diameter of 12.5 mm and a thickness of 1.3 mm.

The obtained molded body was fired at 1320° C. for two hours in the air to give a sintered body. The shape of the sintered body was a circular disc shape having a diameter of 10.5 mm and a thickness of 1.1 mm.

In Experiment example 1, all of Examples and Comparative examples used the dielectric element bodies having the same composition and shape.

### (Multilayer Electrode)

In each sample except for Sample No. 1, the multilayer electrode 13 was formed on the both main surfaces of the dielectric element body. A main component metal of each electrode layer was as shown in Table 1. Also, spattering was performed while appropriately changing the spattering target so that a thickness of each electrode was as shown in Table 1.

### (Fired Electrode)

In Sample No. 1, a fired electrode made of Cu was formed on the both main surfaces of the dielectric element body. A Cu paste including a glass frit was applied on the both main surfaces of the dielectric element body so that a thickness of the fired electrode obtained at the end was 5000 nm (5 μm).

### (Soldering)

The multilayer electrode (outermost electrode layer) and a lead terminal (lead part) were connected via a solder. Then, an epoxy resin was applied to cover the electric element body, and the exterior part was formed.

A capacitance C, a permittivity ε, and tan δ were measured by applying 1 kHz and AC current of 1 Vrms at 20° C. to each capacitor sample. The permittivity ε of 1000 or greater was deemed good, and 5000 or greater was deemed even better. In Experiment example 1, all of Examples and Comparative examples exhibited “C” of 4700 pF and ε of 9000. Regarding tan δ, it varied depending on the structure of the multilayer electrode. The measurement results of tan δ are shown in Table 1. When tan δ was 2.5% or less, it was deemed good, and 1.4% or less was deemed even better.

An insulation resistance IR was measured by applying DC current of 500 V at 20° C. to both ends of each capacitor sample. In Experiment example 1, all of the samples exhibited IR of 3.0×10⁵ MΩ.

Regarding AC breakdown electric field intensity VB, AC electric field was applied, while gradually increasing the AC electric field, to both ends of the capacitor of each sample. The electric field value at the moment when a leakage current of 100 mA was detected was deemed VB. For the VB measurement, 10 capacitors were tested per each sample. The average (Av.) of the measured VB and the standard deviation (σ) of the measured VB are shown in Table 1. Table 1 shows the results of evaluation. The average of VB of 8.0 kV/mm or greater was deemed good. The standard deviation of VB of 6.0 kV/mm or less was deemed good, and 4.0 kV/mm or less was deemed even better.

For a Ring Wave test, first, Ring Wave of an open circuit voltage of 4.0 kV and frequency of 100 kHz was applied for twenty times to the capacitor sample of each sample. Next, Ring Wave was applied for twenty times under the same condition except that the applied direction of the voltage was reversed. At this point, the noise upon applying the Ring Wave and exterior appearances of each sample after the Ring Wave application were observed to verify the electrostrictive breakdown.

Next, the open circuit voltage was increased by 1 kV and the same test was carried out to the capacitor which did not exhibit electrostrictive breakdown. The same test was repeated while incrementally increasing the open circuit voltage by 1 kV until electrostrictive breakdown was confirmed. The open circuit voltage at the time of the electrostrictive breakdown was deemed a breakdown voltage. Then, the breakdown voltage was measured from ten capacitors per each sample. The average of the obtained breakdown voltages of each sample is shown in Table 1.

For evaluation of a soldering property, Sn-3.0Ag-0.5Cu lead free solder (M705 made by SENJU METAL INDUSTRY CO., LTD.) was used. The sample prior to soldering was immersed in a nonactivated-rosin flux. Then, the sample was immersed in a solder tank of a temperature at 245±2° C. for three seconds. Regarding the capacitor after the immersion in the solder tank, an area newly covered with the solder was obtained. When the area covered with solder was 95% or greater, it was deemed good; when the area was between 90% or greater and less than 95%, it was deemed fair; and when the area was less than 90%, it was deemed fail. Table 1 shows the results of evaluation. There was no sample which failed in the soldering property.

A high temperature accelerated test was carried out to the capacitor of each sample after soldering under the same conditions of a temperature at 125° C. and the applied voltage of 1000 Vac for a test duration of 2000 hours. IR of the capacitor before the high temperature accelerated test and IR of the capacitor after the high temperature accelerated test were compared, and when IR after the high temperature accelerated test dropped by less than one digit, it was deemed “good”; if IR dropped by one digit or greater and less than two digit, it was deemed “fair”; and if IR dropped by two digits or greater, it was deemed “fail”. Table 1 shows the results of evaluation. There was no sample which exhibited “fail” in the high temperature accelerated test.

A heat cycle test was performed to the capacitor after the soldering. The below described step (i) to step (iv) were performed as one heat treatment cycle. Said one heat treatment cycle includes a step (i) maintaining the capacitor for 30 minutes under a temperature condition which makes the temperature of each sample to −55° C., a step (ii) increasing the temperature of the sample to 125° C. within three minutes, a step (iii) maintaining the sample for 30 minutes under the condition which makes the temperature of the sample to 125° C., and a step (iv) decreasing the temperature of the sample to −55° C. within 3 minutes.

After repeating said one heat treatment cycle for 3000 times to 10 capacitors per each sample, the capacitance of each capacitor was measured. A damage ratio was obtained by calculating a number ratio of the capacitors which the capacitance dropped by 20% or greater compared to the capacitance C before the heat treatment cycle. When the damage rate was less than 10%, that is, not one capacitor was damaged, it was deemed “good; when the damage rate was 10% or more and 20% or less, that is, 1 to 2 capacitor(s) was damaged, it was deemed “fair”; and when the damage rate of more than 20%, that is, three or more capacitors were damaged then it was deemed “fail”. Table 1 shows the results of evaluation. There was no sample which exhibited “fail” in the heat cycle test.

TABLE 1

| | | Electrode | | | | | | | | |
|---|---|---|---|---|---|---|---|---|---|---|
| | | Main component metal | | | | Thickness (nm) | | | | |
| | | | Inside- | Outside- | | | Inside- | Outside- | | |
| | Example/ | Innermost | middle | middle | Outermost | Innermost | middle | middle | Outermost | |
| Sample | Comparative | electrode | electrode | electrode | electrode | electrode | electrode | electrode | electrode | |
| No. | example | layer | layer | layer | layer | layer | layer | layer | layer | t2/t1 |
| 1 | Comparative | Cu | None | None | None | 5000 | None | None | None | 0.0 |
| | example | | | | | | | | | |
| 2 | Comparative | Cu | None | Ni | Cu | 300 | None | 100 | 100 | 0.0 |
| | example | | | | | | | | | |
| 3a | Example | Ti | Cu | Ni | Cu | 30 | 260 | 100 | 100 | 8.7 |
| 3 | Example | Ti | Cu | Ni | Cu | 50 | 260 | 100 | 100 | 5.2 |
| 4 | Example | Ti | Cu | Ni | Cu | 100 | 260 | 100 | 100 | 2.6 |
| 5 | Example | Ti | Cu | Ni | Cu | 150 | 260 | 100 | 100 | 1.7 |
| 6 | Example | Ti | Cu | Ni | Cu | 200 | 260 | 100 | 100 | 1.3 |
| 7 | Example | TI | Cu | Ni | Cu | 100 | 100 | 100 | 100 | 1.0 |
| 8 | Example | Ti | Cu | Ni | Cu | 100 | 130 | 100 | 100 | 1.3 |
| 4 | Example | Ti | Cu | Ni | Cu | 100 | 260 | 100 | 100 | 2.6 |
| 9 | Example | Ti | Cu | Ni | Cu | 100 | 390 | 100 | 100 | 3.9 |
| 10 | Example | Ti | Cu | Ni | Cu | 100 | 500 | 100 | 100 | 5.0 |
| 11 | Example | Ti | Cu | Ni | Cu | 100 | 260 | 30 | 100 | 2.6 |
| 12 | Example | Ti | Cu | Ni | Cu | 100 | 260 | 50 | 100 | 2.6 |
| 4 | Example | Ti | Cu | Ni | Cu | 100 | 260 | 100 | 100 | 2.6 |
| 13 | Example | Ti | Cu | Ni | Cu | 100 | 260 | 150 | 100 | 2.6 |
| 14 | Example | Ti | Cu | Ni | Cu | 100 | 260 | 300 | 100 | 2.6 |
| 15 | Example | Ti | Cu | Ni | Cu | 100 | 260 | 100 | 30 | 2.6 |
| 16 | Example | TI | Cu | Ni | Cu | 100 | 260 | 100 | 50 | 2.6 |
| 4 | Example | Ti | Cu | Ni | Cu | 100 | 260 | 100 | 100 | 2.6 |
| 17 | Example | Ti | Cu | Ni | Cu | 100 | 260 | 100 | 150 | 2.6 |
| 18 | Example | Ti | Cu | Ni | Cu | 100 | 260 | 100 | 300 | 2.6 |
| 19 | Example | Ti | Cu | Ni | Cu | 200 | 100 | 100 | 100 | 0.5 |
| 6 | Example | Ti | Cu | Ni | Cu | 200 | 260 | 100 | 100 | 1.3 |
| 20 | Example | Ti | Cu | Ni | Cu | 200 | 300 | 100 | 100 | 1.5 |
| 21 | Example | Ti | Cu | Ni | Cu | 150 | 130 | 100 | 100 | 0.9 |
| 4 | Example | Ti | Cu | Ni | Cu | 100 | 260 | 100 | 100 | 2.6 |
| 22 | Example | Ti | Cu | Ni | Cu | 70 | 220 | 100 | 100 | 3.1 |
| 23 | Example | Ti | Cu | Ni | Cu | 55 | 150 | 100 | 100 | 2.7 |
| 24 | Example | Ti | Cu | Ni | Cu | 150 | 260 | 100 | 100 | 1.7 |
| 25 | Example | Ti | Cu | Ni | Cu | 150 | 260 | 100 | 100 | 1.7 |
| 5 | Example | Ti | Cu | Ni | Cu | 150 | 260 | 100 | 100 | 1.7 |
| 26 | Example | Ti | Cu | Ni | Cu | 150 | 260 | 100 | 100 | 1.7 |
| 27 | Example | Ti | Cu | Ni | Cu | 150 | 260 | 100 | 100 | 1.7 |
| 28 | Comparative | Ni | Cu | Ni | Cu | 150 | 100 | 100 | 100 | 0.7 |
| | example | | | | | | | | | |
| 29 | Comparative | Ni | Cu | Ni | Cu | 100 | 260 | 100 | 100 | 2.6 |
| | example | | | | | | | | | |

| | Dielectric element body | | | | | | | | | |
|---|---|---|---|---|---|---|---|---|---|---|
| | Main | | | | | | | | | |
| | component | Sub- | | | | Ring Wave | | | | |
| | Zr/ | component | | | | | Im- | | | |
| | (Ti + Zr) | MnO | Capacitor | | | Breakdown | prove- | | | |
| | in terms | parts | | VB | | voltage | ment | Soldering | High temp. | Heat |
| Sample | of number | by | tanδ | Av. | σ | Av. | rate | property | accelerated | cycle |
| No. | of atoms | weight | [%] | [kV/mm] | [kV/mm] | [kV] | [%] | test | test | test |
| 1 | 0.16 | 0.03 | 1.2 | 11.1 | 2.0 | 6.0 | — | Good | Good | Good |
| 2 | 0.16 | 0.03 | 1.2 | 10.6 | 3.3 | 6.0 | — | Good | Good | Good |
| 3a | 0.16 | 0.03 | 1.2 | 10.5 | 5.3 | 7.5 | 25 | Good | Good | Fair |
| 3 | 0.16 | 0.03 | 1.2 | 11.9 | 3.8 | 8.8 | 47 | Good | Good | Good |
| 4 | 0.16 | 0.03 | 1.2 | 9.5 | 2.3 | 9.0 | 50 | Good | Good | Good |
| 5 | 0.16 | 0.03 | 1.3 | 9.6 | 1.7 | 9.3 | 55 | Good | Good | Good |
| 6 | 0.16 | 0.03 | 1.5 | 9.6 | 4.4 | 10.0 | 67 | Good | Fair | Good |
| 7 | 0.16 | 0.03 | 1.2 | 10.4 | 2.9 | 9.2 | 53 | Good | Fair | Good |
| 8 | 0.16 | 0.03 | 1.2 | 10.3 | 2.8 | 9.5 | 58 | Good | Fair | Good |
| 4 | 0.16 | 0.03 | 1.2 | 10.7 | 2.9 | 9.0 | 50 | Good | Good | Good |
| 9 | 0.16 | 0.03 | 1.2 | 10.3 | 3.2 | 9.2 | 53 | Good | Good | Good |
| 10 | 0.16 | 0.03 | 1.2 | 9.0 | 2.5 | 9.3 | 55 | Good | Good | Fair |
| 11 | 0.16 | 0.03 | 1.2 | 9.5 | 2.9 | 9.1 | 52 | Good | Fair | Good |
| 12 | 0.16 | 0.03 | 1.2 | 3.2 | 3.2 | 9.6 | 60 | Good | Good | Good |
| 4 | 0.16 | 0.03 | 1.2 | 9.5 | 2.3 | 9.0 | 50 | Good | Good | Good |
| 13 | 0.16 | 0.03 | 1.2 | 9.2 | 2.8 | 9.3 | 55 | Good | Good | Good |
| 14 | 0.16 | 0.03 | 1.2 | 10.9 | 2.8 | 9.1 | 52 | Good | Good | Fair |
| 15 | 0.16 | 0.03 | 1.2 | 9.9 | 2.5 | 9.0 | 50 | Fair | Good | Good |
| 16 | 0.16 | 0.03 | 1.2 | 9.8 | 3.0 | 9.4 | 57 | Good | Good | Good |
| 4 | 0.16 | 0.03 | 1.2 | 9.5 | 2.3 | 9.0 | 50 | Good | Good | Good |
| 17 | 0.16 | 0.03 | 1.2 | 9.8 | 3.1 | 9.1 | 52 | Good | Good | Good |
| 18 | 0.16 | 0.03 | 1.2 | 10.9 | 2.4 | 9.4 | 57 | Good | Good | Good |
| 19 | 0.16 | 0.03 | 1.5 | 9.3 | 4.7 | 9.4 | 57 | Good | Fair | Good |
| 6 | 0.16 | 0.03 | 1.5 | 9.6 | 4.4 | 10.0 | 67 | Good | Fair | Good |
| 20 | 0.16 | 0.03 | 1.5 | 8.9 | 4.7 | 9.7 | 62 | Good | Fair | Good |
| 21 | 0.16 | 0.03 | 1.2 | 9.9 | 2.6 | 9.5 | 58 | Good | Fair | Good |
| 4 | 0.16 | 0.03 | 1.2 | 9.5 | 2.3 | 9.0 | 50 | Good | Good | Good |
| 22 | 0.16 | 0.03 | 1.2 | 11.3 | 2.6 | 9.3 | 55 | Good | Good | Good |
| 23 | 0.16 | 0.03 | 1.2 | 9.5 | 2.9 | 9.0 | 50 | Good | Good | Good |
| 24 | 0.16 | 0.01 | 1.3 | 10.0 | 2.9 | 8.4 | 40 | Good | Good | Good |
| 25 | 0.16 | 0.02 | 1.3 | 9.6 | 2.9 | 8.9 | 48 | Good | Good | Good |
| 5 | 0.16 | 0.03 | 1.3 | 9.6 | 1.7 | 9.3 | 55 | Good | Good | Good |
| 26 | 0.16 | 0.04 | 1.3 | 11.3 | 2.6 | 9.2 | 53 | Good | Good | Good |
| 27 | 0.16 | 0.08 | 1.3 | 10.1 | 2.3 | 8.9 | 48 | Good | Good | Good |
| 28 | 0.16 | 0.03 | 1.2 | 9.8 | 2.8 | 7.0 | 17 | Good | Fair | Good |
| 29 | 0.16 | 0.03 | 1.2 | 10.7 | 2.7 | 6.9 | 15 | Good | Good | Good |

In Sample No. 1 and Sample No. 2, the electrode layers were different types and had different shapes. Even when the multilayer electrode which both the innermost electrode layer and the outermost electrode layer included Cu as the main component as shown in Sample No. 2 was used, there was no difference in the Ring Wave test results compared to the case which used the fired electrode including Cu as a main component as shown in Sample No. 1.

Also, regarding Sample No. 2, there was no difference in the Ring Wave test results, when the thickness of the innermost electrode layer was changed within a range of 180 to 600 nm, when the thickness of the outside-middle electrode layer was changed within a range of 30 to 300 nm, and when a thickness of the outermost electrode layer was changed within a range of 30 to 300 nm.

In Experiment example 1, the improvement rate of the breakdown voltage was changed with respect to the breakdown voltage of the Ring Wave test of Sample No. 1. Specifically, the improvement rate of 25% or greater was deemed good, and 50% or greater was deemed even better. The improvement rate of the breakdown voltage was evaluated with respect to the breakdown voltage of the Ring Wave test of Sample No. 2 gave the same evaluation results.

Sample Nos. 3a, 3 to 6 were the samples in which the innermost electrode layer of Sample No. 2 using Cu as the main component was changed to a two-layer structure which included the innermost electrode layer using Ti as the main component and the inside-middle electrode layer including Cu as the main component; and also, the thickness of the innermost electrode layer was varied. Samples 3a, 3 to 6 in which the innermost electrode layers were an electrode layer having Ti as the main component exhibited good Ring Wage test results. Further, for other tests, the results were also all good.

For Sample Nos. 7 to 18, the tests were performed under the same conditions except that the thickness of the inside-middle electrode layer, the outside-middle electrode layer, or the outermost electrode layer of the Sample No. 4 was varied. Similarly to Sample No. 4, Sample Nos. 7 to 18 exhibited good Ring Wave test results. Further, for other tests, the results were also all good.

For Sample Nos. 19 and 20, the tests were performed under the same conditions except that the thickness of the inside-middle electrode layer was changed from that of the Sample No. 6. Similarly to Sample No. 6, Sample Nos. 19 and 20 exhibited good Ring Wave test results. Further, for other tests, the results were also all good.

For Sample Nos. 21 to 23, the tests were performed under the same conditions except that the thicknesses of the innermost electrode layer and the inside-middle electrode layer were varied from those of the Sample No. 4. Similarly to Sample No. 4, Sample Nos. 21 to 23 exhibited good Ring Wave test results. Further, for other tests, the results were also all good.

For Sample Nos. 24 to 28, the tests were performed under the same conditions except that the thickness of the inside-middle electrode layer was changed from that of the Sample No. 4. The content of MnO in each sample was a very small amount, thus, the content of MnO did not affect the test results except for the Ring Wave test. It was confirmed that the change in the content of MnO had influence on the Ring Wave test results.

Sample Nos. 28 and 29 were samples using Ni as the main component for the innermost electrode layer which is different from Sample Nos. 3 to 27. In the case that the main component of the innermost electrode layer was Ni, the improvement rate of the breakdown voltage of a Ring Wave test did not sufficiently increase.

### Experiment Example 2

Unlike Experiment example 1, in Experiment example 2, the composition and shape of the dielectric element body were changed.

A content ratio of Ca with respect to a total amount of Ba and Ca which were included as A-site elements of the main component (BCTZ) included in the dielectric element body obtained at the end was adjusted to (Ca/(Ba+Ca)) of 0 in terms of the number of atoms. That is, Ba was only used as the A-site element. Also, a content ratio of Zr with respect to a total amount of Ti and Zr included as B-site elements of the main component (BCTZ) included in the dielectric element body obtained at the end was adjusted to (Zr/(Ti+Zr)) of 0. That is, Ti was only used as the B-site element.

The shape of the dielectric element body was a circular disc shape having a diameter of 4.5 mm and a thickness of 1.0 mm. “C” was 470 pF, ε was 3000, and IR was 1.0×10⁶ MΩ.

For Sample No. 31, a fired electrode using Cu as the main component similarly to Sample No. 1 was used. Note that, the thickness of the fired electrode was changed to 4000 nm (4 μm). For Sample No. 32, a multilayer electrode having the similar configuration as the examples in Experiment example 1 was used to the above-mentioned dielectric element body. Table 2 shows the results of evaluation.

Note that, the improvement rate with respect to the breakdown voltage of Sample No. 31 was deemed the improvement rate of a Ring Wave test.

TABLE 2

| | | Electrode | | | | | | | | |
|---|---|---|---|---|---|---|---|---|---|---|
| | | Main component metal | | | | Thickness (nm) | | | | |
| | | | Inside- | Outside- | | | Inside- | Outside- | | |
| | Example/ | Innermost | middle | middle | Outermost | Innermost | middle | middle | Outermost | |
| Sample | Comparative | electrode | electrode | electrode | electrode | electrode | electrode | electrode | electrode | |
| No. | example | layer | layer | layer | layer | layer | layer | layer | layer | t2/t1 |
| 31 | Comparative | Cu | None | None | None | 4000 | None | None | None | 0.0 |
| | example | | | | | | | | | |
| 32 | Example | Ti | Cu | Ni | Cu | 150 | 200 | 100 | 100 | 1.3 |

| | Dielectric element body | | | | | | | | | |
|---|---|---|---|---|---|---|---|---|---|---|
| | Main | | | | | | | | | |
| | component | | | | | RingWave | | | | |
| | Zr/ | Sub- | | | | | Im- | | | |
| | (Ti + Zr) | component | Capacitor | | | Breakdown | prove- | | | |
| | in terms | MnO | | VB | | voltage | ment | Soldering | High temp. | Heat |
| Sample | of number | parts by | tanδ | Av. | σ | Av. | rate | property | accelerated | cycle |
| No. | of atoms | weight | [%] | [kV/mm] | [kV/mm] | [kV] | [%] | test | test | test |
| 31 | 0.00 | 0.03 | 0.9 | 6.6 | 1.9 | 12.0 | — | Good | Good | Good |
| 32 | 0.00 | 0.03 | 1.2 | 7.2 | 1.7 | 15.0 | 25.0 | Good | Good | Good |

Regarding Sample Nos. 31 and 32, when compared to the samples of Experiment example 1, the Ring Wave test results changed mainly along with the change in the dielectric element body. Further, since Sample No. 32 used the multilayer electrode having the specific composition, the Ring Wave test results improved compared to Sample No. 31.

### Experiment Example 3

Sample No. 51 was tested under the similar conditions as Sample No. 4 except that Sample No. 51 used the multilayer electrode having a two-layer structure in which the innermost electrode layer included Ti and the outermost electrode layer included Cu. Sample No. 52 was tested under the similar conditions as Sample No. 4 except that Sample No. 52 used the multilayer electrode having a two-layer structure in which the innermost electrode layer included Ti and the outermost electrode layer included Ni. Table 3 shows the results of evaluation.

TABLE 3

| | | Electrode | | | | | | | | Dielectric element body |
|---|---|---|---|---|---|---|---|---|---|---|
| | | Main component metal | | | | Thickness (nm) | | | | Main component |
| | | | Inside- | Outside- | | | Inside- | Outside- | | Zr/(Ti + Zr) |
| | Example/ | Innermost | middle | middle | Outermost | Innermost | middle | middle | Outermost | in terms of |
| | Comparative | electrode | electrode | electrode | electrode | electrode | electrode | electrode | electrode | number of |
| Sample No. | example | layer | layer | layer | layer | layer | layer | layer | layer | atoms |
| 1 | Comparative | Cu | None | None | None | 5000 | None | None | None | 0.16 |
| | example | | | | | | | | | |
| 51 | Example | Ti | None | None | Cu | 130 | None | None | 80 | 0.16 |
| 52 | Example | Ti | None | None | Ni | 110 | None | None | 75 | 0.16 |
| 4 | Example | Ti | Cu | Ni | Cu | 100 | 260 | 100 | 100 | 0.16 |

| | Dielectric element body | | | | Ring Wave | | | | |
|---|---|---|---|---|---|---|---|---|---|
| | Subcomponent | Capacitor | | | Breakdown | | | | |
| | MnO | | VB | | voltage | Improvement | Soldering | High temp. | Heat |
| | parts by | tanδ | Av. | σ | Av. | rate | property | accelerated | cycle |
| Sample No. | weight | [%] | [kV/mm] | [kV/mm] | [kV] | [%] | test | test | test |
| 1 | 0.03 | 1.2 | 11.1 | 2.0 | 6.0 | — | Good | Good | Good |
| 51 | 0.03 | 1.2 | 10.4 | 2.8 | 9.2 | 53.3 | Good | Fair | Good |
| 52 | 0.03 | 1.3 | 9.0 | 3.2 | 8.5 | 41.7 | Fair | Fair | Good |
| 4 | 0.03 | 1.2 | 9.5 | 2.3 | 9.0 | 50.0 | Good | Good | Good |

According to Table 3, in the case of using the multilayer electrode which at least the innermost electrode layer included Ti as the main component, it was confirmed that the Ring Wave test results can be improved sufficiently.

### REFERENCE SIGNS LIST

1 . . . . Capacitor
11 . . . . Dielectric element body
13 . . . . Multilayer electrode
13a . . . . Innermost electrode layer
13b . . . . Inside-middle electrode layer
13c . . . . Outside-middle electrode layer
13d . . . . Outermost electrode layer
15 . . . . Solder
17 . . . . Lead part
19 . . . . Exterior part

What is claimed is:

1. An electronic device, comprising:
a dielectric element body, a multilayer electrode connected to a surface of the dielectric element body, and a lead part connected to a surface of the multilayer electrode;
wherein the multilayer electrode comprises an innermost electrode layer contacting the dielectric element body and an outermost electrode layer contacting the lead part; and
the innermost electrode layer comprises a Ti membrane mainly including Ti, and the outermost electrode layer comprises a metal membrane.

2. The electronic device according to claim 1, wherein the outermost electrode layer is a Cu membrane mainly including Cu.

3. The electronic device according to claim 1, wherein a thickness of the innermost electrode layer is 50 nm or thicker.

4. The electronic device according to claim 1, wherein a thickness of the innermost electrode layer is 150 nm or thinner.

5. The electronic device according to claim 1, wherein the dielectric element body includes a perovskite oxide as a main component.

6. The electronic device according to claim 5, wherein the perovskite oxide includes one or more elements selected from the group consisting of Ba and Ca as an A-site element, and one or more elements selected from the group consisting of Ti and Zr as a B-site element.

7. The electronic device according to claim 6, wherein a content ratio of Zr to a total amount of Ti and Zr included as the B-site element in the perovskite oxide is greater than 0 and 0.20 or less in terms of number of atoms.

8. The electronic device according to claim 5, wherein the dielectric element body includes MnO as a subcomponent.

9. The electronic device according to claim 1, wherein a thickness of the outermost electrode layer is between 50 nm or thicker and 150 nm or thinner.

10. The electronic device according to claim 1, wherein the multilayer electrode comprises at least one middle electrode layer between the innermost electrode layer and the outermost electrode layer.

11. The electronic device according to claim 10, wherein the at least one middle electrode layer includes an outside-middle electrode layer contacting the outermost electrode layer, and the outside-middle electrode layer comprises a Ni membrane mainly including Ni.

12. The electronic device according to claim 11, wherein a thickness of the outside-middle electrode layer is between 50 nm or thicker and 150 nm or thinner.

13. The electronic device according to claim 11 comprising an inside-middle electrode layer between the innermost electrode layer and the outside-middle electrode layer, and the inside-middle electrode layer comprises a Cu membrane mainly including Cu.

14. The electronic device according to claim 13, wherein a thickness of the inside-middle electrode layer is between 130 nm or thicker and 390 nm or thinner.

15. The electronic device according to claim 13, wherein a thickness t1 of the innermost electrode layer and a thickness t2 of the inside-middle electrode layer satisfy a relation of t2/t1 of 1.6 or greater.

16. The electronic device according to claim 1, wherein the multilayer electrode comprises a spattered membrane.
